(19) United States
(12) Patent Application Publication
(10) Pub. No.: US 2003/0090707 A1
(43) Pub. Date: May 15, 2003

(54) Methods and systems for making booklets

(76) Inventors: Shell Simpson, Boise, ID (US); Ward Scott Foster, Boise, ID (US); Kris R. Livingston, Boise, ID (US)

Correspondence Address: HEWLETT-PACKARD COMPANY, Intellectual Property Administration, P.O. Box 272400, Fort Collins, CO, 80527-2400, US

(21) Appl. No.: 10/053,174

(22) Filed: Nov. 13, 2001

(51) Int. Cl. B41J 1/00; B41F 1/00; G06F 15/00

(52) U.S. Cl. 358/1.15; 358/1.18

(57) ABSTRACT

Methods and systems for making booklets are described. In one embodiment, software enables a user to browse to a network-accessible (e.g. Web-accessible) booklet-making service. The user can specify, to the booklet-making service, imaging data that is to be used to make a booklet and how that imaging data is to be used. The booklet-making service can then construct a booklet incorporating the imaging data that was specified by the user. In further embodiments, the user can print and/or save their booklet.

### TECHNICAL FIELD

This invention relates to printing and distributed environments, and more particularly to methods and systems for making booklets.

### BACKGROUND

As computer technology has advanced, the role of computers in our daily lives has expanded, as has the need for various peripheral or supporting devices. One typical peripheral device used with computers is a printer, which generates a hard copy of data that is used by the computer. The types and capabilities of printers available has similarly been expanding, resulting in a wide variety of printers with a range of printing capabilities, performance, and price.

One significant expansion in the use of computer technology is the networking of computers together. Networking computers together allows the computers to communicate with one another as well as with other devices, such as printers. As computer networks, such as the Internet, continue to develop, there is an increasing demand for additional and improved functionalities that draw upon and exploit the full computing potential of computer networks.

Accordingly, this invention arose out of concerns associated with providing improved systems and methods for printing in a distributed environment.

### SUMMARY

Methods and systems for making booklets are described. In one embodiment, software enables a user to browse to a network-accessible (e.g. Web-accessible) booklet-making service. The user can specify, to the booklet-making service, imaging data that is to be used to make a booklet and how that imaging data is to be used. The booklet-making service can then construct a booklet incorporating the imaging data that was specified by the user. In further embodiments, the user can print and/or save their booklet.

### BRIEF DESCRIPTION OF THE DRAWINGS

FIG. 1 illustrates an exemplary distributed system in which pre-defined print option configurations can be used.

FIG. 2 illustrates an exemplary distributed system illustrating the use of pre-defined print option configurations in a distributed environment in additional detail.

FIG. 3 illustrates an exemplary web-based architecture in which predefined printer configurations can be used.

FIG. 4 illustrates an exemplary user interface presented by a web browser.

FIG. 5 illustrates an exemplary user interface presented by a web browser.

FIG. 6 illustrates an exemplary user interface presented by a web browser.

FIG. 7 illustrates an exemplary user interface presented by a web browser.

FIG. 8 diagrammatically illustrates a booklet-making process.

FIG. 9 is a flow diagram that describes steps in a method in accordance with one embodiment.

FIG. 10 is a block diagram of an exemplary computer system that is suitable for use in implementing one or more embodiments.

### DETAILED DESCRIPTION

Overview

Methods and systems for making booklets are described. In one embodiment, software enables a user to browse to a network-accessible (e.g. Web-accessible) booklet-making service. The user can specify, to the booklet-making service, imaging data that is to be used to make a booklet and how that imaging data is to be used. The booklet-making service can then construct a booklet incorporating the imaging data that was specified by the user. In further embodiments, the user can print and/or save their booklet.

Exemplary Distributed System

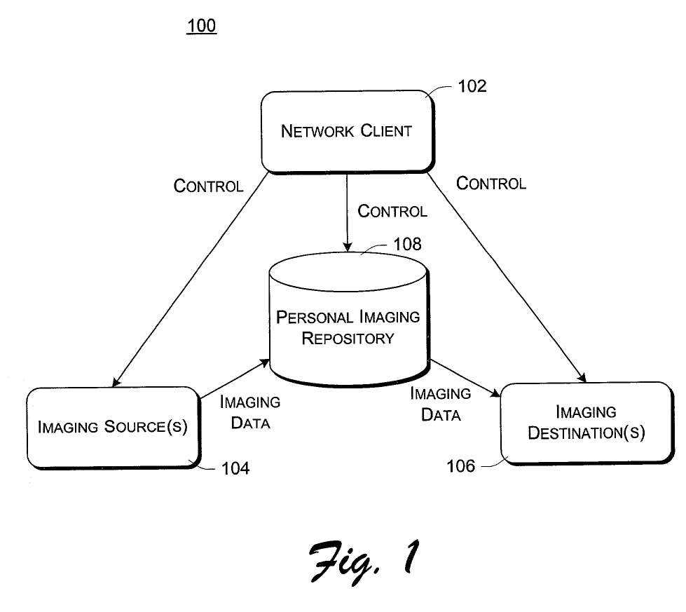

FIG. 1 illustrates an exemplary distributed system 100 in which various embodiments described below can be implemented. In system 100, a network client device 102 is in communication with one or more imaging sources 104, one or more imaging destinations 106, and a personal imaging repository 108. A user of client device 102 can communicate with imaging source(s) 104 to select or identify images to be stored in personal imaging repository 108 in the form of imaging data. Imaging sources 104 represent any of a wide variety of devices that are capable of providing images to other devices. Examples of imaging sources 104 can include computers, cameras (e.g., digital still or video cameras), scanners, applications, Web sites, and so forth.

Repository 108 represents image storage facilities personalized to the individual user, although alternatively multiple users may have access to the same repository 108. Repository 108 is maintained on one or more computers, such as network client 102, an imaging source(s) 104, an imaging destination(s) 106, another computer (not shown), or combinations thereof. The imaging data in repository 108 can be any type of printable data, such as text, drawings, frames of video or animations, pictures, combinations thereof, and so forth.

The user, via network client 102, can select images from imaging repository 108 to be communicated to imaging destination(s) 106 for printing. In one aspect, the selected images from the repository can be communicated to the imaging destination in accordance with pre-defined print option configurations identified by the user, and as described in co-pending patent application Ser. No. 09/905,506, entitled “Pre-defined Print Option Configurations for Printing in a Distributed Environment”, naming Shell Simpson, Ward Foster, and Kris Livingston as inventors, bearing Attorney Docket No. 10008181, the disclosure of which is incorporated by reference.

Imaging destination 106 represents any of a wide variety of devices that are capable of processing images in some manner. Examples of imaging destinations 106 include printers, plotters, services managing printing devices, and so on.

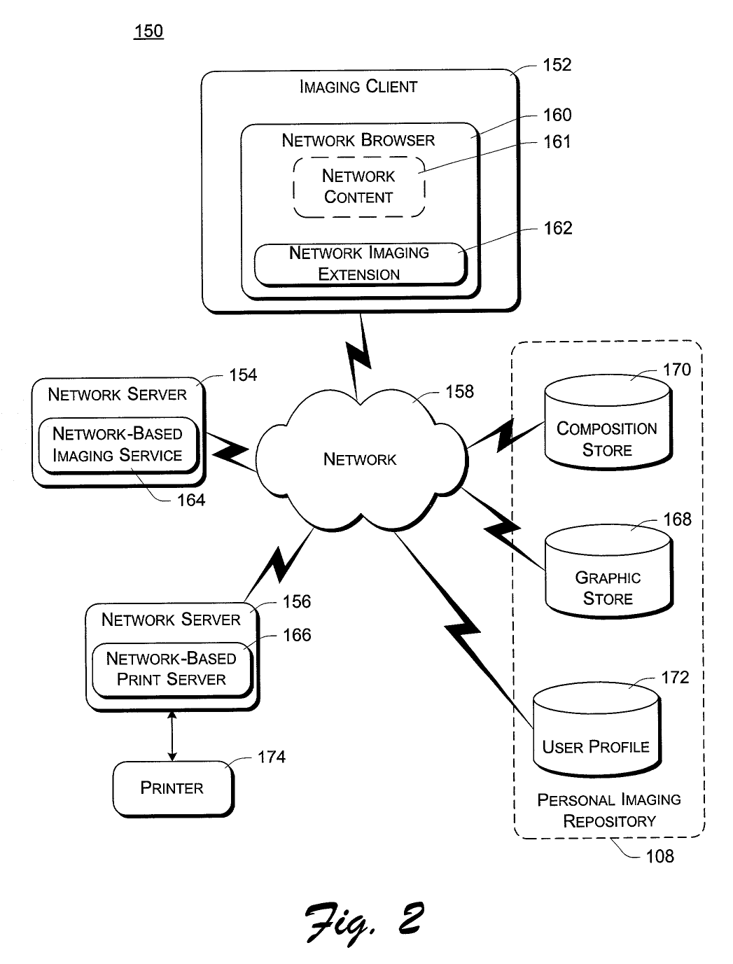

FIG. 2 shows an exemplary distributed system 150 in a distributed environment in additional detail. System 150 includes an imaging client 152 coupled to multiple network servers 154 and 156 via a network 158. Client 152 and servers 154 and 156 represent any of a wide variety of conventional wired and/or wireless computing devices, such as desktop computers, portable computers, dedicated server computers, multi-processor computing devices, cellular telephones, personal digital assistants (PDAs), handheld or pen-based computers, gaming consoles, and so forth.

Network 158 represents one or more conventional data distribution networks that can be used to communicate data and other information (e.g., control information) between or among various computing devices. Examples of network 158 include the Internet, a local area network (LAN), a public or private wide area network (WAN), combinations thereof, and so on. Network 158 can include multiple different types of networks, including wired and/or wireless portions, employing any of a wide variety of different communications protocols, including public and/or proprietary communications protocols.

During operation, a network browser 160 executing on imaging client 152 allows a user of client 152 to interact with network servers 154 and 156, as well as network services executing on such servers. Network browser 160 includes a network imaging extension 162 that allows network content 161 executing in browser 160 to communicate with the user's personal imaging repository 108, which may include communication with services via network 158. As used herein, services refer to software components that can execute on one or more computing devices and are accessible to provide functionality to imaging client 152, such as imaging sources, imaging destinations, printer configuration components, booklet maker components and so forth. Network imaging extension 162 can be implemented in any of a wide variety of manners, such as an application programming interface (API) providing methods that can be called by content 161 and used to interact with servers 154 and 156 (e.g., to load, save, modify, delete, etc. documents).

Network server 154 executes a network-based imaging service 164 that allows a user of browser 160 to interact with his or her personal imaging repository (e.g., add, remove, and/or modify graphics in the repository) and identify an image for printing. Images identified or selected for including in the user's personal imaging repository can be indicated by value (e.g., the actual image data) or by reference (e.g., a pointer to or identifier of the image stored elsewhere). The image to be printed can be made up of graphics from one or more different graphic sources, and include any type of printable data (e.g., text, graphics, and so forth).

Network-based imaging service 164 represents one or more services accessible to imaging client 152. Each service can execute on the same server or alternatively on multiple different servers. These different services can provide different functionality (e.g., one service may be responsible for graphic storage and retrieval functionality, while another service is responsible for merge functionality allowing graphics to be merged together). Additionally, some services may be fully or partially overlapping in functionality provided by other services, allowing a degree of fault-tolerance to be built into system 150 (e.g., one service can take over the responsibilities of another if the other fails).

The graphic for an image is received from a graphic store 168 and/or a composition store 170. Graphic store 168 stores individual graphics (also referred to as documents or more generally data capable of being represented as a two dimensional graphic), such as individual files. These individual graphics in store 168 can be used as individual printable images via imaging service 164. Each individual graphic can be any of one or more types of printable data (e.g., text, pictures, etc.), and may result in multiple hard copy pages when printed. Additionally, a user of browser 160 may identify multiple individual graphics from graphic store 168 that are to be compiled together as a single image for printing. In this situation, network-based imaging service 164 provides an interface that allows the user of browser 160 to select different individual images and store the compilation of individual images as a single composition document (also referred to as a composition image) in composition store 170. The composition document may include the actual data from the individual images, or alternatively identifiers (e.g., file name and path, or Uniform Resource Locators (URLs)) of where the individual images can be retrieved for printing or displaying to the user.

Graphic store 168 and composition store 170 are illustrated in system 150 as two separate stores. Alternatively, multiple such stores may exist in system 150, and one or more graphic stores may be combined with one or more composition stores. Additionally, one or more of these stores 168 or 170 may be implemented on one of servers 154 or 156, and/or imaging client 152.

Network-based imaging service 164 also provides an interface via which a user of browser 160 can access imaging data in the form of documents, pages of documents, and portions thereof, and manipulate and arrange them into a composition document or page. In addition, an interface to a booklet maker service can be provided so that the user can access various documents and arrange them into booklet form for printing. The service can allow the user to preview the booklet they are assembling at any point during the assembly process, as will become apparent below.

In order to print an image, the user identifies the image (optionally selecting graphics that are to be part of the image). A print request, including the image data is then communicated to network-based print server 166 executing on network server 156. Upon receipt of the print request, network-based printer server 166 interacts with a printer 174 coupled thereto to produce a hard copy of the image in accordance with the received image data.

Exemplary Web-Based Architecture

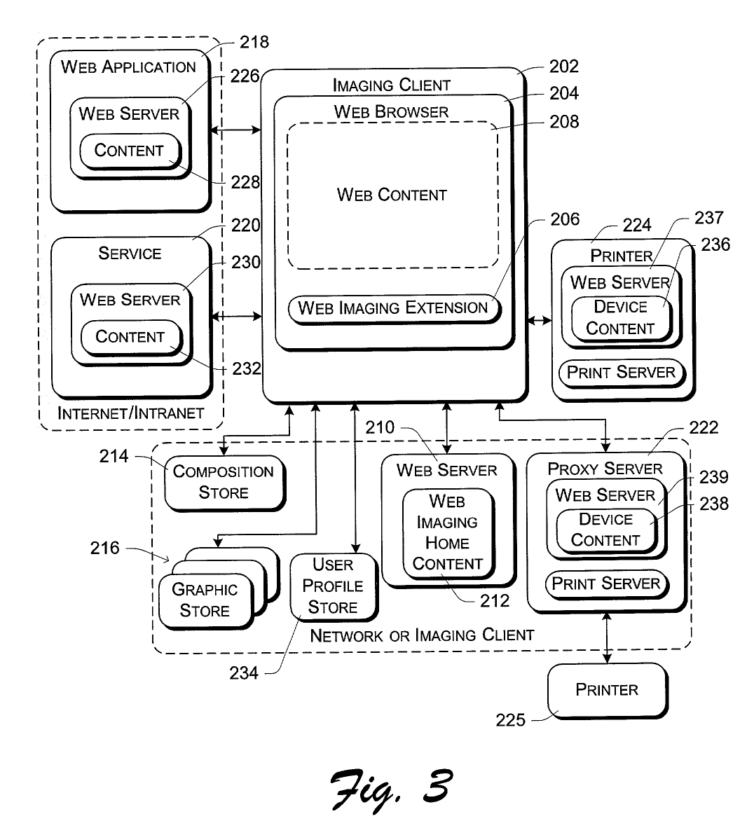

FIG. 3 illustrates an exemplary Web-based architecture 200 that is suitable for use in implementing the various described embodiments. Web-based architecture 200 refers to the World Wide Web (or simply the Web), which is a distributed collection of interlinked, user-viewable documents (typically referred to as Web documents or Web pages) that are accessible via the Internet. The Web also refers to the client and server components which provide user access to such documents using standardized Internet protocols. Currently, the primary standard protocol for allowing applications to locate and acquire Web documents is the HyperText Transport Protocol (HTTP), and the Web pages are encoded using a standard markup language such as the HyperText Markup Language (HTML) or extensible Markup Language (XML). Alternatively, other protocols or languages may be used.

In architecture 200, an imaging client 202 (i.e., similar to imaging client 152 of FIG. 2) includes a Web browser 204 including a web imaging extension 206. Browser 204 is able to load and execute web content 208 (e.g., Java scripts or programs) from various sources. In the illustrated example, Web browser 204 establishes a communication channel or connection with Web server 210, causing Web imaging home content 212 to be copied to imaging client 202 as at least part of Web content 208. Although illustrated as being copied from Web server 210, it is to be appreciated that Web imaging home content 212 could alternatively be loaded from a local or intermediary source, such as a cache (not shown) implemented on imaging client 202. Additionally, any inputs by the user to Web content 208 are typically handled by Web content 208 rather than being returned to Web imaging home content 212.

Once loaded in Web browser 204, Web content 208 can communicate, via Web imaging extension 206, with other components in architecture 200, allowing access to a personal imaging repository as well as imaging sources and imaging destinations. In the illustrated example, the personal imaging repository includes composition store 214 and graphic store 216, the imaging sources include Web application 218 and service 220, and the imaging destinations include proxy server 222 and printer 224.

Web application 218 includes a Web server 226 that maintains (or obtains/creates) content 228 accessible to Web content 208. Similarly, service 220 maintains a Web server 230 that maintains (or obtains/creates) content 232 accessible to Web content 208. The content 228 and 232, when generated (e.g., from a file or dynamically) and executed on imaging client 202 (e.g., as part of Web content 208), can make various functionality available to Web content 208, such as image sources, combine multiple graphics into a composition document, manipulate imaging data such as logical pages, graphics and text, as will become more apparent below.

Printer 224 and proxy server 222 each optionally include a print server for queuing and managing received print requests, and a Web server 237 and 239 for storing or dynamically generating device content 236 and 238, respectively. Device content 236 represents content (which may be generated dynamically) that is provided to the Web browser 204 by the Web server 237. Device content 236 is a Web service available to imaging client 202 that represents printer 224 and that can access the user's personal imaging repository. The device content 236, when downloaded and executed on client 202 (e.g., as part of Web content 208), can access the stores 214 and 216 via Web imaging extension 206 to obtain graphics and upload the graphics to printer 224 for printing. The upload to printer 224 is accomplished using existing conventional mechanisms (e.g., HTTP POSTs or TCP/IP socket connections) that allow content executing within the browser to communicate with the server from which that content came. In the illustrated example, imaging extension 206 is only used to obtain graphics from the personal imaging repository, not to upload the graphics to the printer.

Proxy server 222 allows a printer(s) that does not host a Web server to be represented by a Web service. Proxy server 222 includes device content 238 and Web server 239, which operate analogous to device content 236 and Web server 237, respectively. The printer 225 is represented by device content 238 and graphics obtained by the device content 238 (presented in the context of the device). This device content, when downloaded and executed on client 202 (e.g., as part of Web content 208), can upload graphics accessed through the imaging extension to proxy server 222, which in turn forwards these graphics to printer 225.

Web application 218 and service 220 may each be accessible by imaging client 202 via the Internet or via a local network (e.g., an Intranet). Each of the stores 214 and 216, as well as user profile store 234, Web server 210, and proxy server 222, may be accessible via a network (e.g., an Intranet or the Internet) and/or located on imaging client 202.

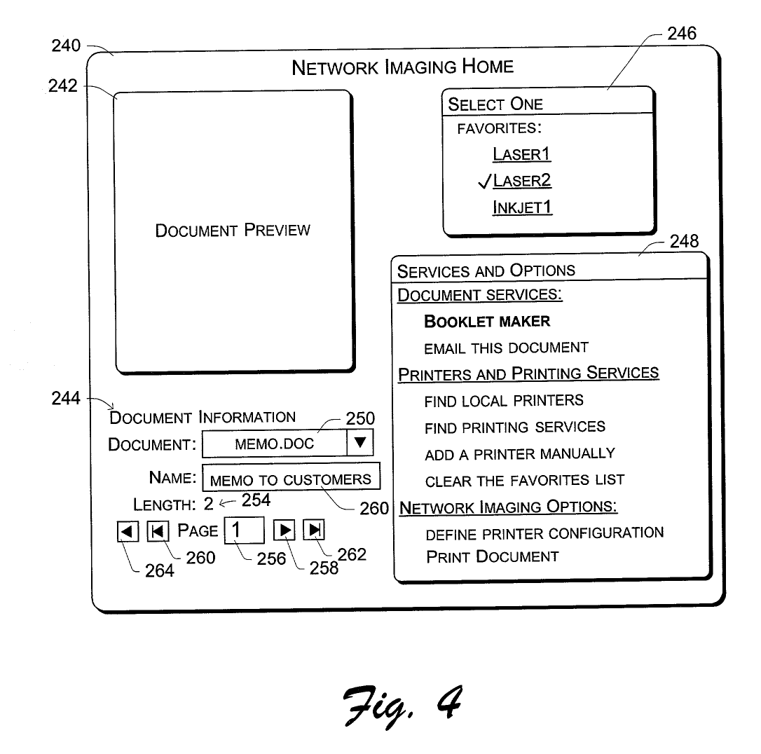

During operation, Web content 208 generates and renders, via Web browser 204, one or more user interfaces (e.g., graphical user interfaces (GUIs)) that allows the user to interact with his or her personal imaging repository. This interaction includes allowing the user to select images or documents for printing, to identify pre-defined printer configurations to be used in printing selected documents, to select imaging data and manipulate or otherwise arrange the imaging data for printing, to construct booklets and the like. Example user interfaces rendered by Web content 208 are discussed below with reference to FIGS. 4-7. The various interfaces can be separate Web pages, or alternatively portions of another (or the same) Web page.

Exemplary UIs

FIG. 4 illustrates an exemplary user interface presented by Web browser 204 of FIG. 3. In the illustrated example, user interface 240 is displayed by Web browser 204 as a result of loading the Web imaging home content 212. User interface 240 includes a document preview window 242, a document information portion 244, a favorite printers portion 246, and a services and options portion 248. User interface 240 allows the user to select one or more documents for printing via document information portion 244. The user can select the desired document by name via a pull down menu input 250 or change the name of the selected document in name field 260. Alternatively, other document-selection input mechanisms may be supported, such as cutting and pasting of the document name, dragging and dropping an icon representing the document, supporting a “browse” feature allowing the user to search his or her personal imaging repository (or elsewhere) for documents, and so forth.

The length of the user-selected document (e.g., in pages) is illustrated in a length field 254. Document preview window 242 provides a location via which a small preview image of the document selected for printing (or other processing) is displayed to the user. The document preview window 242 can also be used to build booklets or otherwise manipulate imaging data, as will be described in more detail below. A current page section 256 identifies the current page(s) being displayed in document preview window 242, and page manipulation buttons 258, 260, 262, and 264 allow the user to easily advance to the next page in the document, the previous page in the document, the last page of the document, or the first page of the document, respectively.

Favorite printers portion 246 identifies one or more printers that are selectable by the user for printing, and can include, for example, the user's preferred printers, suggested printers to be used by the user, default printers, and so forth. In the illustrated example, each printer identified in favorites portion 246 is identified by a hyperlink (illustrated as being underlined). The user can select one of the printers that the identified document is to be printed on by activating the hyperlink (e.g., by using a pointer control device to situate a pointer over the hyperlink on screen and click a button of the control device).

Services and options portion 248 allows the user to identify or request options or services, such as to add a printer to favorites portion 246, clear favorites portion 246, print the document, and so forth.

One of the services available for selection on the services and options portion 248 is a “booklet maker” portion. In this embodiment, a user can select this option so that they can arrange imaging data into booklet form for printing. The functionality that can be provided by selecting this option can comprise any functionality that can be utilized to manipulate or otherwise arrange imaging data to form a booklet for printing. Such manipulations and arrangements can include, without limitation, scaling, rotating, translating, and/or providing multiple different individual pages or documents on a single page for printing. The multiple different pages can comprise multiple different pages from a single common composition document, or multiple different pages from multiple different composition documents. Specific examples of how this particular functionality can be implemented are described in co-pending application Ser. No. 09/941,065, entitled “Methods and Systems for Arranging Content for Printing in a Distributed Environment”, naming as inventors Shell S. Simpson, Ward S. Foster, and Kris R. Livingston, bearing Docket No. 10008258, the disclosure of which is incorporated by reference herein.

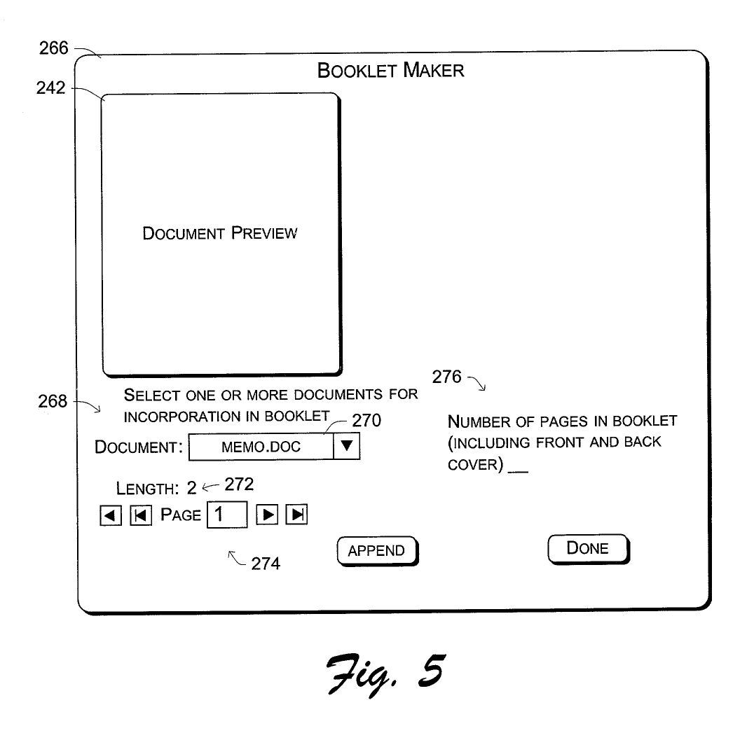

FIG. 5 shows an exemplary user interface 266 that is presented by Web browser 204 of FIG. 3 responsive to a user selecting the “booklet maker” service. In the illustrated example, user interface 266 (entitled “Booklet Maker”) is displayed by Web browser 204 as a result of loading the content corresponding to the booklet making service hosted on some web server, such as perhaps on service 220, web application 218, printer 220, proxy server 222, or web server 212. As in the above user interface, user interface 266 includes a document preview window 242. In addition, a selection portion 268 is provided and enables a user to select one or more documents for incorporation into a booklet. The documents can desirably be selected from the user's personal imaging repository or other locations. The user can select one or more of the desired documents using a pull down menu input 270. The length of a selected document is illustrated in a length field 272. The user can navigate through their selected document(s) using manipulation buttons indicated generally at 274.

In addition, a field 276 is provided and can contain an indicator that informs the user of the number of pages the booklet will have, based on the user's selection of documents. In this particular example, the number of pages entered by the user includes the front and back covers. In one embodiment, this can involve simply calculating the smallest multiple of four that is greater than or equal to the number of pages in the selected document. Additionally, the number of sheets may be displayed, where a sheet is a single piece of paper that, when folded in half and printed on both sides, provides four pages of a booklet. User-selectable options for the booklet can also include the paper size to be printed on (e.g., Letter, Legal, A4, etc), where each page of the booklet is printed on half of one side of that size piece of paper. Another option can include providing a choice of whether or not the last page of the document should be forced to the back cover of the booklet by inserting up to three blank pages before it.

An “Append” button (not specifically designated) can also be provided and can enable the user to incorporate multiple source documents into a single booklet. Specifically, the “Append” button can enable the user to select documents and have them appended to the end of an initially empty list of documents that comprise the booklet. Each time the Append button is clicked, a list of documents can be updated in the UI and the total length of the booklet, as described above, can also be updated to reflect the appended document.

When the user is done selecting and appending the document or documents that are going to be incorporated in their booklet, they can click a “Done” button (not specifically designated) in order to advance to the next user interface.

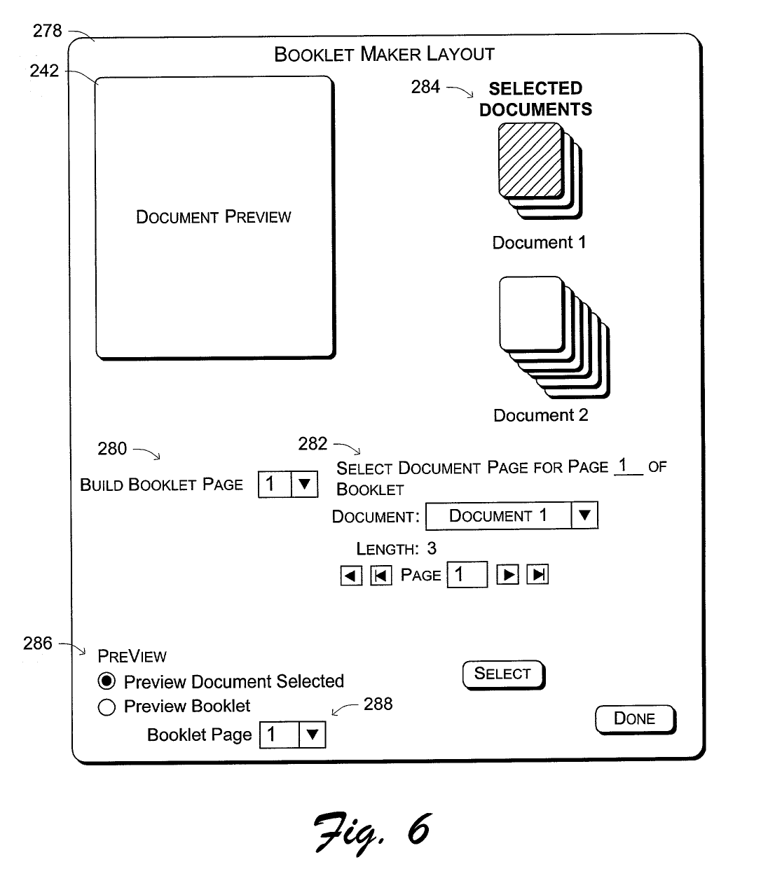

FIG. 6 shows a user interface 278 that is presented to a user during the course of constructing a booklet. At this point in the process, the user has selected one or more documents for use in the booklet construction process. User interface 278 (entitled “Booklet Maker Layout”) enables the user to specify the physical layout of their booklet using the documents they have selected.

User interface 278 includes a “Build Booklet Page” field 280 that enables a user to specify which page of their booklet they are building. In the present example, the user has selected page 1 to begin building. A drop down menu can facilitate the user's navigation through their booklet. A field 282 is provided and enables a user to select a document page for a particular specified booklet page. Iconic representations of the selected documents are displayed at 284. As an example, the user has selected to begin building page 1 of their booklet (as indicated in field 280). For use as page 1 of their booklet, the user, utilizing field 282, has indicated that they wish to use page 1 of document 1 (indicated by the cross-hatching in the figure). Field 282 also permits the user to navigate through their selected document or documents. Once the user has settled upon a particular document page to incorporate in their booklet, they can click on the “Select” button (not specifically designated) to select the choice. The user can then proceed, using field 280 to select the next booklet page to build, and field 282 to select the document page for incorporation in the next booklet page.

It should be noted that the model described above can be simplified in some embodiments. That is, given that most documents already present in the repository will have their pages in appropriate order, the user can simply specify the order of whole documents, and possibly delete specific pages from the resulting sequence and/or insert blank pages to force a section to begin on the correct side of a leaf.

To assist the user in visualizing their booklet, a preview field 286 is provided. In this example, the preview field has two selectable choices—a “preview document selected” choice, and a “preview booklet” choice. If the user selects the “preview document selected” choice, then preview window 242 can display the currently-indicated document page (as indicated in field 282). If the user selects the “preview booklet” choice, then the preview window can display a visual representation of their booklet in its current state of construction. A booklet page field 288 having a pull down menu feature can enable the user to page through their booklet. Alternately, a series of document navigation controls such as those shown at the bottom of field 282 can be provided. This can greatly facilitate the user's construction activities by giving them a chance to preview and edit their booklet before they print it.

Alternately, the preview window can be configured in a default setting that always shows the booklet layout. Accordingly, the user can do all the page insertion and deletion necessary without a separate document view.

When the user has finished selecting the document pages for their booklet, they can click on the “Done” button (not specifically designated).

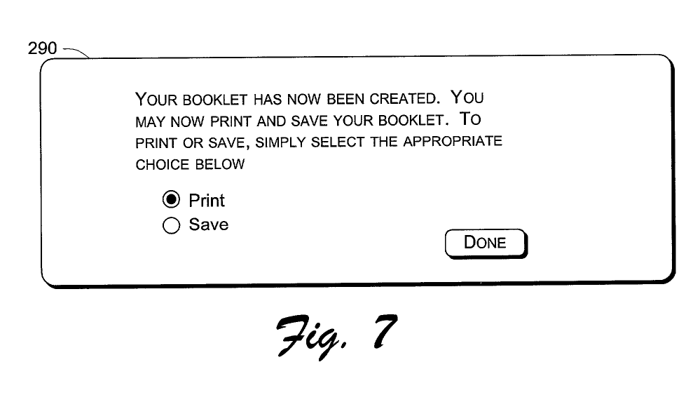

FIG. 7 shows a user interface 290 that can be presented to a user upon completion of their booklet construction. User interface 290 gives the user the option of printing their booklet or saving their booklet, or both. If the user selects the “print” option, they can then be given a choice of print options which can vary among the number of printers available. Exemplary print options can include options such as saddle stitching and paper size. If the user selects the “save” option, their booklet can be saved as a composition document to their personal imaging repository, or any other user-specified location.

Exemplary Booklet Making Process

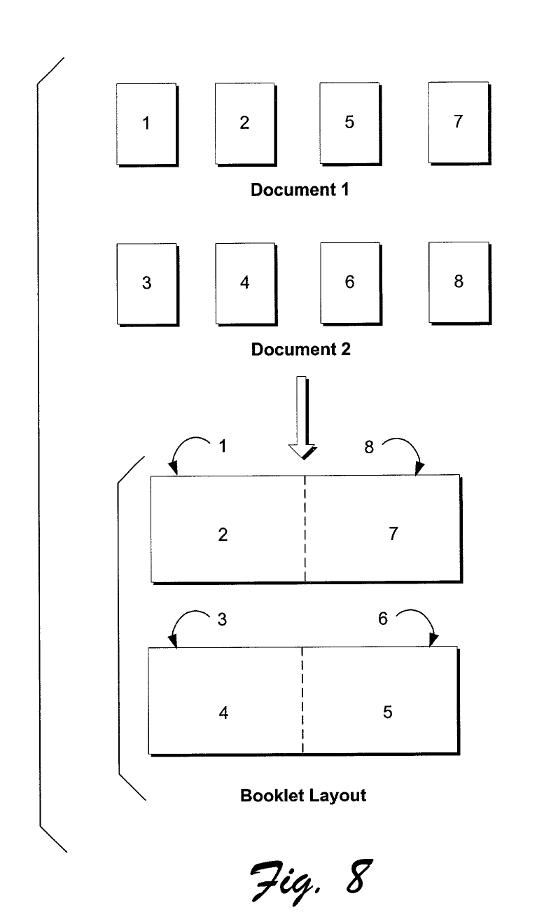

FIG. 8 illustrates an exemplary booklet making process. The booklet-making process is desirably implemented in software as a service.

To initiate a booklet-making process, the user first captures imaging content or data that is going to be used to make their booklet. Imaging content can be captured from any suitable location using any suitable means. For example, the user can retrieve imaging content from their personal imaging repository. Alternately, the user can capture imaging content via a scanner, any suitable desktop applications, web applications and the like. The user then browses, using their browser, to the above-described booklet-making service and interacts with the booklet-making service as described above.

In this example, the user has selected two different documents comprising imaging content that is to be used in their booklet. The documents, designated “Document 1” and “Document 2” each have four pages. Below the two documents a booklet layout is indicated. Notice that each of the individual pages of each document has a number associated with it. Specifically, the pages of Document 1 have numbers 1, 2, 5, and 7 respectively; and the pages of Document 2 have numbers 3, 4, 6, and 8 respectively. The significance of the numbers is that each number represents a booklet page upon which the individual page is to appear. So, for example, the page of Document 1 designated “1” will comprise the first page of the booklet that the user is building. Similarly, the page designated “7” (the fourth page of Document 1) will comprise the seventh page of the booklet that the user is building.

Notice in this example that the user is building an eight-page booklet. Referring now to the booklet layout, notice that there are two physical sheets of paper that are folded to comprise the booklet. The top sheet has numbers 1, 2, 8, and 7 associated with it and the bottom sheet has numbers 3, 4, 6, and 5 associated with it. The significance of these numbers is that they coincide with the numbers associated with each page of the individual documents and represent the location where each document page will be printed to form the booklet. Specifically, consider the top most booklet layout sheet having the numbers 1, 2, 8, and 7 associated therewith. When this particular sheet is printed in the booklet-printing process, the page designated “1” of Document 1 will be printed on the left half of the reverse side of the booklet sheet as indicated by the curved arrow designator. Similarly, when this particular sheet is printed, the page designated “8” (i.e. the fourth physical page of Document 2) will be printed on the right half of the reverse side of the booklet sheet as indicated by the curved arrow designator. The pages designated “2” and “7” (i.e. the second and fourth physical pages of Document 1) will be printed on this particular sheet in the positions shown. A similar operation takes place for the lowermost booklet sheet having the numbers 3, 4, 6, and 5 associated therewith.

When the booklet is assembled by placing the lowermost booklet sheet on top of the topmost booklet sheet, and folded in half, the booklet now contains each of the pages from Documents 1 and 2 in the order prescribed by the user.

The booklet maker service can then finish the booklet-making process by stapling or processing the printed booklet pages in any manner designated by the user.

It is to be appreciated and understood that the booklet-making service can perform the above described functions automatically. Further, to construct the booklet as designated by the user, the booklet-making service can also automatically scale, rotate, or otherwise manipulate the imaging data comprising each page in order to fit the imaging data onto a booklet page. Examples of such manipulations are described in application Ser. No. 09/941,065 (Docket No. 10008258), incorporated by reference above.

Exemplary Printing Process

Returning to FIG. 3, the process of printing a document in system 200 can be seen from the following example. Via the interface provided by Web browser 204 and content 208, the user is able to access images from different imaging sources, such as Web application 218, service 220, graphic store 216, or composition store 214. Additionally, as described above, the user is able, through the provided user interfaces, to build one or more booklets by selecting, arranging and manipulating various pages from one or more documents. The user can also select, if provided, one of a variety of predefined printer configurations stored in user profile store 234. Exemplary printer configurations are described in the U.S. Patent Application incorporated by reference above. In accordance with this incorporated disclosure, the user can select a printer on which to print the selected document, such as printer 225 coupled to proxy server 222, or printer 224. When the user selects the print option, an identification of the document, in this case a booklet document or composition document (as well as an identification of the configuration, if selected) is communicated to the appropriate printer. Upon receipt of the print request, the printer prints the requested booklet as specified by the user, applying all of the requested print options in the configuration that it supports (e.g., functions that the printer offers (such as stapling) and that the printer is equipped to perform (depending on such as being loaded with staples)).

The print request communicated to the printer includes an identifier of the document, in this case the booklet, that is to be printed. Any of a wide variety of identifiers can be used, such as a Uniform Resource Locator (URL). This may be an identifier of a single document (e.g., a document in graphic store 216), or an identifier of a composition document (e.g., a document in composition store 214) that itself includes identifiers of one or more other documents or pages from other documents. Alternatively, the data of the document to be printed may be communicated to the printer from the client 202, such as by the device content 236 of FIG. 3 (when downloaded and executed on the client 202). The data of the document may be communicated with the print request, or alternatively subsequent to the print request.

Exemplary Methods

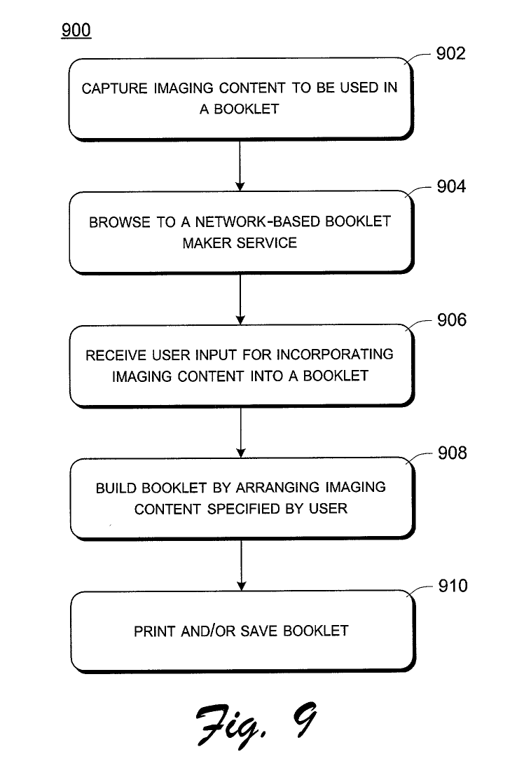

FIG. 9 is a flowchart illustrating an exemplary booklet making process 900 for enabling a user to create a booklet. The process of FIG. 9 is desirably performed by the above-described network-based or Web-based service which, as described, can be embodied in content 208, content 228, content 232, content 212, device content 236 or device content 238.

Step 902 captures imaging content to be used in a booklet. The imaging content can be captured in any suitable way using any suitable means. Non-limiting examples of how this can be done are given above. Step 904 browses to a network-based booklet maker service. This step is implemented via a user's browser executing on a client device. Step 906 receives user input for incorporating imaging content into a booklet. This step can be implemented in any suitable way. In the examples above, and particularly those discussed in connection with FIGS. 5-7, this step can be implemented by causing one or more user interfaces to be displayed on the client device. The user interfaces permit user input to be gathered so that it can be used in the booklet-making process. Exemplary types of user input can include, without limitation, the imaging content (e.g. document(s)) to be used in the booklet-making process, the specific document pages and their associated positions on a printed booklet, the number of pages in a booklet, and the like. In addition, in some embodiments, the user interfaces can provide a document preview window via which the user can view not only the documents that they are using to construct their booklet, but the booklet as well, in various states of construction.

Step 908 builds a booklet by arranging the imaging content specified by the user. This step can be implemented using known booklet-building techniques. But one example of how this can be done is given in connection with FIG. 8. An exemplary booklet-making process is shown and described in U.S. Pat. No. 6,099,225, the disclosure of which is incorporated by reference herein.

After the booklet has been built, step 910 can enable the user to print and/or save the booklet. Examples of how printing and saving can occur are given above.

Some Server Side Issues

Although the inventive embodiments have been described largely in the context of the client side environment, it is to be appreciated and understood that various aspects of the described embodiments can be implemented on the server side. As an example, consider the following. The above-described imaging extension is used to make user information available to content downloaded into the user's browser. In other words, the imaging extension makes information associated with the user's identity available. Thus, one purpose of the imaging extension is to provide access to the user's personal imaging repository.

As was mentioned, this can be accomplished through the imaging extension which extends the behavior of the browser. Although there are advantages to this approach, there are also disadvantages-namely, the browser must somehow be extended. Although it is possible to extend browsers on Windows operating systems, it becomes harder to do this for newer devices like PDAs. Consequently, it is desirable to support the notion of identity without requiring the browser to be extended.

Supporting identity without requiring the browser to be extended can be accomplished by moving the logic normally present in the web content running within the browser into the web server. That is, rather than the web content accessing the user's personal imaging repository, the web server accesses the user's personal imaging repository. In other words, the identity technology is on the server side instead of client side.

One of the problems that arises in this context pertains to the server being able to determine the location of the user's personal imaging repository (more specifically, the user profile which can act as the root of the personal imaging repository). In the client side identity approach, the imaging extension running within the browser implicitly addressed this issue. The content, by virtue of the fact that it is running within the user's browser and accessing the imaging extension, “knows” the identity of the user. For the server, a different approach can be employed since the browser no longer typically provides any sort of hint regarding the user's identity. One approach to solving this problem is to use an authentication website. The website in question can redirect to the authentication website which then determines the identity of the user, and then redirects back to the user with the user identity, including the location of the user's profile. In this scheme, it is assumed that all websites “know” about the authentication server.

Once the user's identity is determined (i.e. the location of the user's profile is know) the website can directly interact with services in the user's personal imaging repository without the aid of the imaging extension. It is also possible to add security to this model. Such could be done using known techniques.

Exemplary Computer System

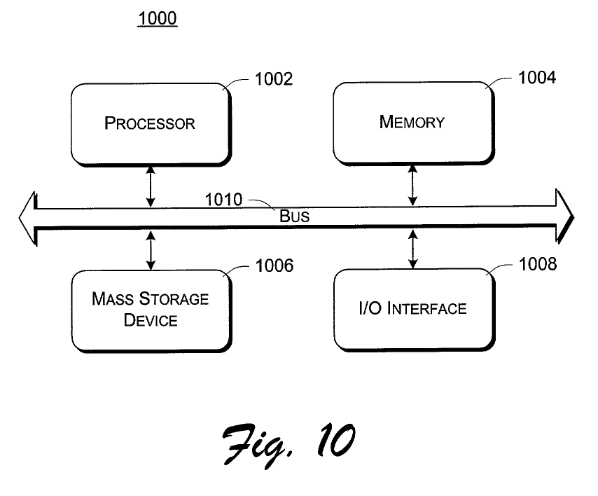

FIG. 10 illustrates an exemplary computer system 1000 in additional detail. Computer system 1000 can be, for example, a network client 102 of FIG. 1, an imaging client 152 or server 154 or 156 of FIG. 2, an imaging client 202, server 210 or 222 of FIG. 3, etc. Computer system 1000 represents a wide variety of computing devices, such as desktop computers, portable computers, dedicated server computers, multi-processor computing devices, cellular telephones, personal digital assistants (PDAs), handheld or pen-based computers, microcontroller-based electronic devices, gaming consoles, and so forth.

Computer system 1000 includes one or more processors 1002, memory 1004, a mass storage device 1006, and an input/output (I/O) interface 1008, all coupled to a bus 1010. Bus 1010 represents one or more buses in computer system 1000, such as a system bus, processor bus, accelerated graphics port (AGP), peripheral component interconnect (PCI), and so forth. The bus architecture can vary by computing device as well as by manufacturer. I/O interface 1008 is a conventional interface allowing components of system 1000 (e.g., processor(s) 1002) to communicate with other computing devices via a network, such as network 158 of FIG. 2. I/O interface 1008 may be, for example, a modem, a network interface card (NIC), and so forth.

Memory 1004 represents volatile and/or nonvolatile memory used to store instructions and data for use by processor 1002. Typically, instructions are stored on a mass storage device 1006 (or nonvolatile memory) and loaded into a volatile memory 1004 for execution by processor(s) 1002. Additional memory components may also be involved, such as cache memories internal or external to processor 1002. Various embodiments can be implemented, at different times, in any of a variety of computer readable media that is part of, or readable by, system 1000. For example, such computer readable media may be mass storage device 1006, memory 1004 or a cache memory, a removable disk (not shown) that is accessible by processor 1002 or another controller of system 1000 (such as a magnet disk or optical disk), and so forth.

Computer system 1000 is exemplary only. It is to be appreciated that additional components (not shown) can be included in system 1000 and some components illustrated in system 1000 need not be included. For example, a display adapter, additional processors or storage devices, additional I/O interfaces, and so forth may be included in system 1000, or mass storage device 1006 may not be included.

I/O interface 1008 is a conventional interface allowing components of system 1000 (e.g., processor 1002) to communicate with other computing devices via a network, such as network 158 of FIG. 2.

The discussions herein refer primarily to software components and modules that can be executed by a computing device. It is to be appreciated, however, that the components and processes described herein can be implemented in software, firmware, hardware, or a combination thereof. By way of example, a programmable logic device (PLD) or application specific integrated circuit (ASIC) could be configured or designed to implement various components and/or processes discussed herein.

### CONCLUSION

The above-described embodiments can greatly facilitate the booklet-making process. The process is flexible and convenient due at least in part to its network-based nature. Further, the user-friendly interfaces can guide a generally novice user through an otherwise difficult process in a manner that masks the difficulties from the user.

Although the description above uses language that is specific to structural features and/or methodological acts, it is to be understood that the invention defined in the appended claims is not limited to the specific features or acts described. Rather, the specific features and acts are disclosed as exemplary forms of implementing the invention.

1. A method comprising:
receiving, via at least one network service, imaging data that is to be included in a booklet;
receiving, via said at least one network service, user input for incorporating the imaging data into the booklet; and
building, via said at least one network service, a booklet incorporating imaging data in accordance with said user input.

2. The method of claim 1 further comprising prior to receiving said imaging data, causing, via at least one network service, a user interface to be presented on a client device, the user interface being configured to enable a user to select imaging data for use in making a booklet, and wherein said receiving imaging data comprises receiving user selection of said imaging data.

3. The method of claim 2, wherein said receiving user selection comprises receiving user selection of multiple documents for use in building said booklet.

4. The method of claim 2, wherein said receiving user selection comprises receiving user selection of multiple documents for use in building said booklet, said multiple documents being retrievable from a user-associated, network-accessible personal imaging repository and further comprising prior to said building, retrieving, via said at least one network service, said multiple documents from the personal imaging repository.

5. The method of claim 2, wherein said acts of causing, receiving user selection, and receiving user input are respectively performed by multiple network services.

6. The method of claim 1, wherein said at least one network service is implemented, at least in part, by at least one printer.

7. The method of claim 1, wherein said at least one network service is implemented, at least in part, by at least one proxy server that serves as a proxy for at least one printer.

8. The method of claim 1 further comprising saving the booklet, via said at least one network service, in a personal imaging repository associated with the user.

9. The method of claim 1 further comprising printing the booklet, via said at least one network service, on a network-accessible printer.

10. One or more computer-readable media having stored thereon computer-readable instructions which, when executed by one or more processors, cause the processors to:
send content to a client device for execution by a client browser, said content enabling the client device to:
display a user interface that is configured to enable a user to select imaging data for use in building a booklet;
provide, over a network, a user selection of imaging data for use in building the booklet;
provide, over the network, user input for incorporating the imaging data into the booklet.

11. One or more computer-readable media as recited in claim 10, wherein the instructions further cause the one or more processors to save, via the network, a booklet that has been built based on the user's input.

12. One or more computer-readable media as recited in claim 10, wherein the instructions further cause the one or more processors to print, via the network, the booklet on one or more network accessible printers.

13. One or more computer-readable media as recited in claim 10, wherein the instructions further cause the one or more processors to provide said user selection and said user input over a network comprising the Internet.

14. A method comprising:
causing, via at least one Web service, a user interface to be presented on a client device, the user interface being configured to enable a user to select imaging data for use in making a booklet;
receiving, via said at least one Web service, a user selection of imaging data;
receiving, via said at least one Web service, user input for incorporating the imaging data into a booklet;
building, via said at least one Web service, a booklet incorporating imaging data received from said user input; and
printing, via said at least one Web service, the booklet on a Web-accessible printer.

15. The method of claim 14 further comprising saving the booklet, via said at least one Web service, in a Web-accessible location.

16. The method of claim 14 wherein said at least one Web service is implemented, at least in part, by at least one printer.

17. The method of claim 14 wherein said at least one network service is implemented, at least in part, by at least one proxy server that serves as a proxy for at least one printer.

18. A method comprising:
receiving, via at least one Web service, a user selection of imaging data that is to be used to build a booklet;
receiving, via said at least one Web service, user input for incorporating the imaging data into the booklet; and
building, via said at least one Web service, a booklet incorporating imaging data received from said user input.

19. The method of claim 18 further comprising providing the user, via said at least one Web service, options to print the booklet on at least one Web-accessible printer and saving the booklet in a Web-accessible location.

20. The method of claim 18, wherein said at least one Web service is implemented, at least in part, by a Web-accessible printer.

21. The method of claim 18, wherein said at least one Web service is implemented, at least in part, by at least one proxy server that serves as a proxy for at least one printer.

22. One or more computer-readable media having stored thereon computer-readable instructions which, when executed by one or more processors, cause the processors to:
receive, via at least one Web service, a user selection of imaging data that is to be used to build a booklet;
receive, via said at least one Web service, user input for incorporating the imaging data into the booklet; and
build, via said at least one Web service, a booklet incorporating imaging data received from said user input.

23. A booklet-making method comprising:
browsing to a Web-accessible booklet-making service;
specifying to said Web-accessible booklet-making service imaging data that is to be used to make a booklet and how that imaging data is to be used; and
constructing, via said Web-accessible booklet-making service, a booklet incorporating the imaging data.

24. The method of claim 23 further comprising printing the booklet via the Web-accessible booklet-making service.

25. A web service comprising:
means, operably associated with the Web, for enabling a user to specify one or more Web-accessible documents for use in building a booklet;
means, operably associated with the Web, for enabling the user to specify one or more pages from the one or more documents and where said one or more pages will reside in the booklet; and
means, operably associated with the Web, for building the booklet.

26. The web service of claim 25 further comprising means for printing the booklet.

27. The web service of claim 25 further comprising means for saving the booklet in a personal imaging repository associated with the user.
